(19) United States
(12) Patent Application Publication
(10) Pub. No.: US 2013/0034379 A1
(43) Pub. Date: Feb. 7, 2013

(54) Welded steel variable angle bamboo connector assembly model BL 12A-B

(71) Applicant: Raymond Collin Pelton, Kurtistown, HI (US)

(72) Inventor: Raymond Collin Pelton, Kurtistown, HI (US)

(21) Appl. No.: 13/315,132

(22) Filed: Mar. 28, 2012

Related U.S. Application Data
(60) Provisional application No. 61/433,119, filed on Jan. 14, 2011.

(51) Int. Cl. F16C 11/10

(52) U.S. Cl. 403/91

(57) ABSTRACT

A mechanical means of connecting natural bamboo or any natural tree pole at the terminal end to side of another natural bamboo or natural tree pole overcoming the inherent problems of the irregular characteristics of the poles in a simple and efficient way. The connector assembly is easily fitted to the poles with small tools and simple construction trade skills. Once fitted with temporary fasteners said connector assembly elements are joined at any angle as in a construction frame by one bolt. The next and most important innovation; a final adjustment opportunity is available to the builder. At this step adjoining elements are locked into a precise mating surface attachment before final securing is performed. This adjustment is an essential function as a means of compensating for the irregularities of natural poles to insure optimal positioning of adjoining poles by means of in place rotation of said connector elements.

This application claims priority to provisional patent application number: 61433119 Filed on 14 Jan. 2011

### FEDERALLY SPONSORED RESEARCH

Not Applicable

### SEQUENCE LISTING OR PROGRAM

Not Applicable

### BACKGROUND

### Field of Invention

In the past and currently, bamboo has been and is being used for building as a structural material. It is known to satisfy a variety of construction needs, surviving time, earthquakes, windstorms and other natural disasters.

Throughout history, man has been concerned in developing construction methods and technologies which will solve the high demand for shelter with efficiency and with low environmental impact. It is therefore advantageous to find a practical joinery system for the use of natural bamboo poles, and also use with natural tree poles. The bamboo plant itself provides many benefits to the growing environment, and can provide many uses besides construction material, such as food value for human and livestock. The benefits of bamboo plant production include protection of water resources, erosion control, and the generation of natural woodland faster than any other forestry resource, and has perpetual self-regeneration. Harvesting never kills the plant which preserves the ecosystem over time.

There is also the potential of high economic impact for regional development for the generation of raw material capital wealth and employment without the use of high cost and damaging effects of heavy equipment.

In other counties the joining of bamboo in construction has enabled a wide range of possibilities due to low cost labor using traditions of tools and techniques that require knowledge and skill not found in North America. The search for prior art in the US and internationally that relates to most construction inadequately addresses the unique characteristics of bamboo in a practical and industry competitive way.

### Disadvantages of Prior Art

Traditional means of joining are not acceptable in the Uniform Building Code at this time in the US.

Contemporary systems are not practical for wide range application and acceptance as a means of utilizing bamboo as an alternative to conventional ways of construction by building professionals, and trade workers. This is due to high labor costs of highly skilled workers. One new system by U. Wanner; US0083605, Apr. 8, 2010 as cited, can only utilize a 3 foot maximum length of bamboo pole before requiring a bulky laminated wood joint that requires epoxy adhesive and uses more material than 20 feet of bamboo, thus making the bamboo material use much less significant. No prior art addresses the irregularities of natural bamboo poles with an adjustable means of compensating for them.

### OBJECTS AND ADVANTAGES OF THIS INVENTION

The object of the invention is to provide an assembly of two joining elements selected from an inventory of sizes of each of said elements. The terminal end element fits the terminal end diameter of a natural bamboo or tree pole. The side element fits to the side diameter of an adjoining pole joint application. The connection is made between said elements by means of a single bolt at a wide range of angles. The invention would function to exceed and enhance the loading strength of that portion of the frame. Therefore said connection would accomplish the design function of this particular location exactly as intended by the frame designer and engineer by means of transferring the loads from one pole member'to another in a simple and user friendly manner.

### Advantages

The advantages of the invention over any traditional or recently developed system are the following:

Each of the elements is attached temporarily at the prescribed location of the frame by means of high strength adjustable circular clamps and the pivoting joint bolts until all the collective joints of the frame are in place. This allows for the adjustment of all locations due to the irregularities of the natural bamboo poles that affect the frame design configuration. Once the builder is satisfied with all the adjusted joint locations the temporary fastening can then be replaced with the appropriate prescribed permanent fastening hardware. Without this unique advantage of adjustability the bamboo would necessarily be forced into position, thus stressing the frame members in undesirable ways with unpredictable outcomes. This adjustable feature allows for the use of longer continuous pole members by designers without concern for the irregularities that are normal in poles that have functional value in lengths up to 60 feet, depending on the timber species. In addition, experienced bamboo builders adapt to the irregularities by taking the advantage of selective pole arrangement utilizing the irregularities by twisting the poles into position after said poles have been joined due to the invention adjustability.

### SUMMARY

My invention consists of a connector assembly of two adjoining adjustable elements. The two elements function as a means of joining the side of a natural bamboo pole to one end of another natural bamboo pole. Side element 12A, consisting of a tube segment and flat pivot plate configuration which joins together by means of a pivot bolt, centered on the two adjacent pivot plates, to the pivot plate of the terminal element flat plate and tube segment configuration at a wide range of angles utilizing in place adjustability after being fastened to their respective poles.

### DRAWINGS

### Brief Description of Drawings

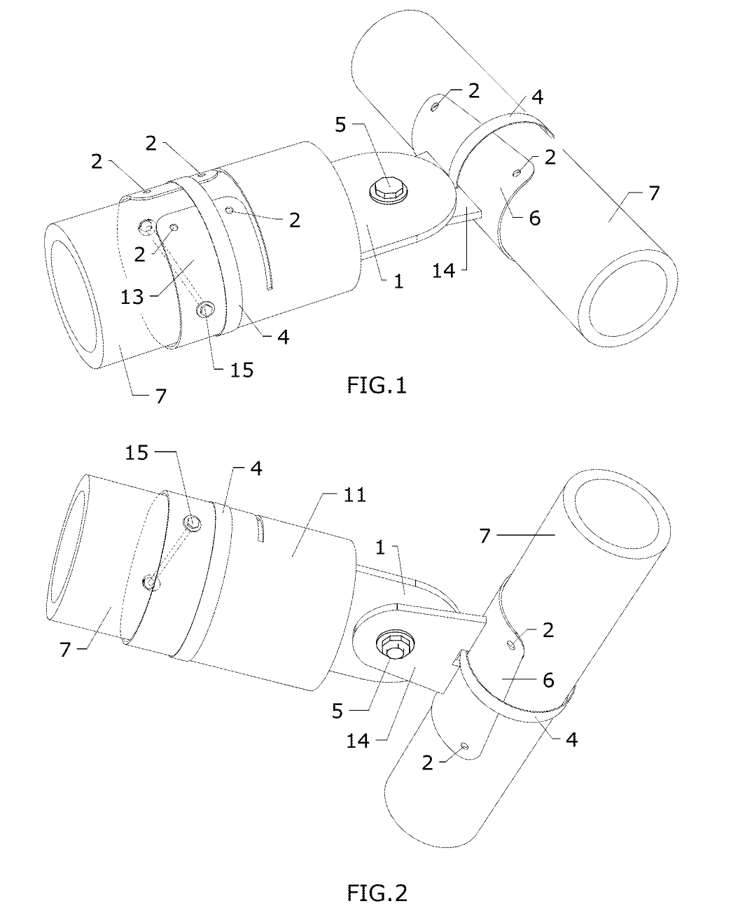

FIG. 1 shows a perspective view in a horizontal plane of the entire invention mounted to segments of bamboo on either side allowing the viewer to clearly see how the invention attaches to the bamboo, including the fastening hardware (screws omitted for clarity).

FIG. 2 shows the entire invention in the vertical plane perspective for additional understanding.

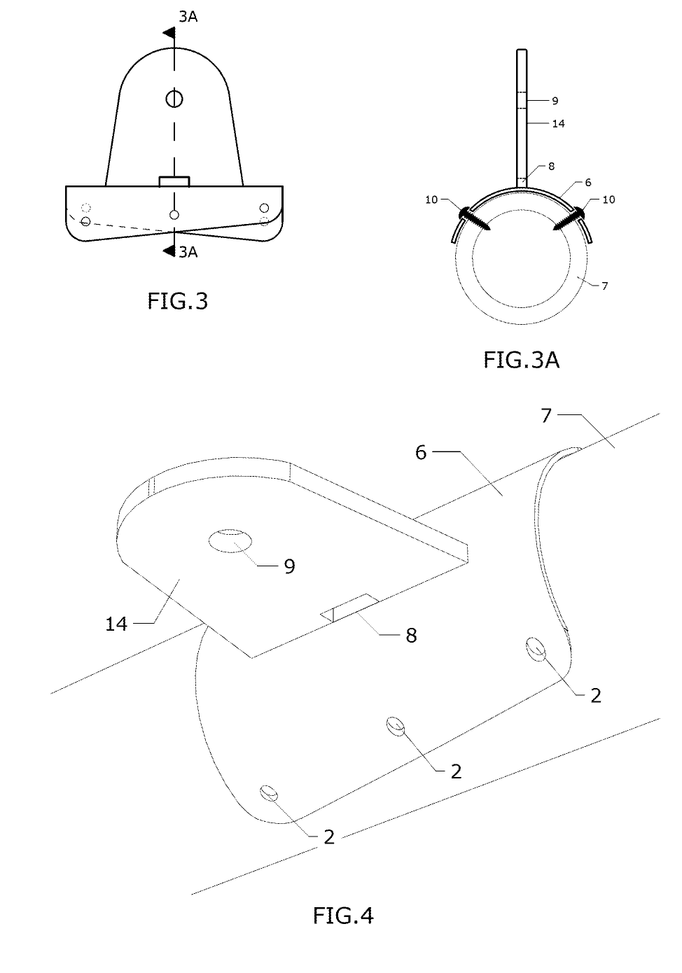

FIG. 3 shows the side view of the element 12A of the invention unmounted, allowing the viewer to understand the tube segment configuration that offsets the set-screw holes to prevent grain splits in the longitude of the bamboo poles.

FIG. 3A shows the end view including set screws in place in element 12A mounted on bamboo pole as fasteners to primarily prevent rotation of said element on the pole, and secondarily as sole means of attachment in light load conditions.

FIG. 4 shows element 12A mounted on bamboo pole in isometric view with no fasteners.

FIG. 5 shows element 12B side view

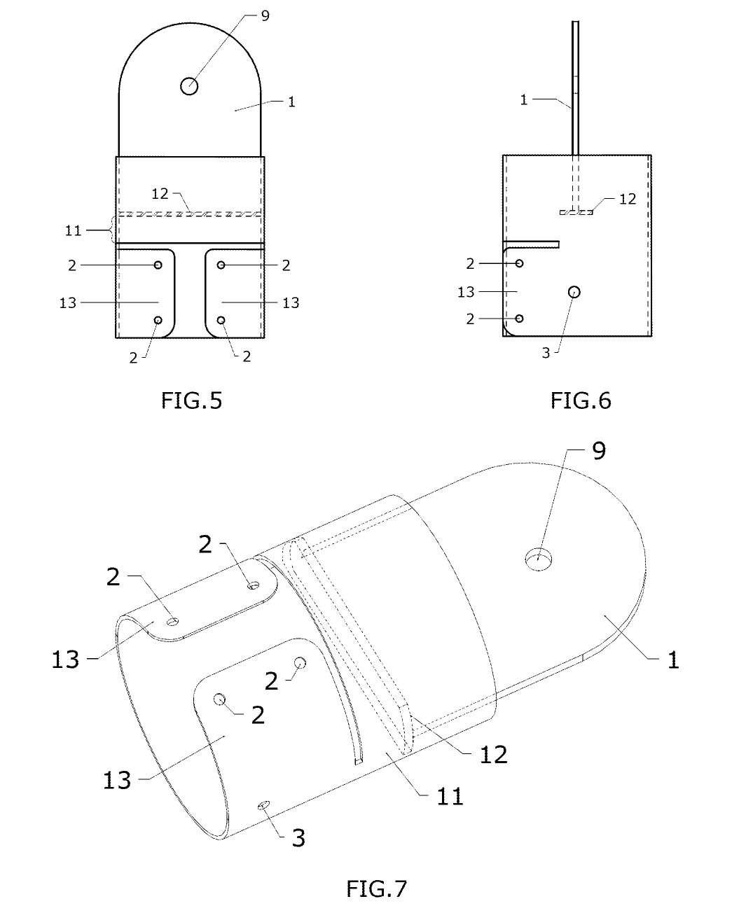

FIG. 6 shows element 12B end view

FIG. 7 shows element 12B perspective view

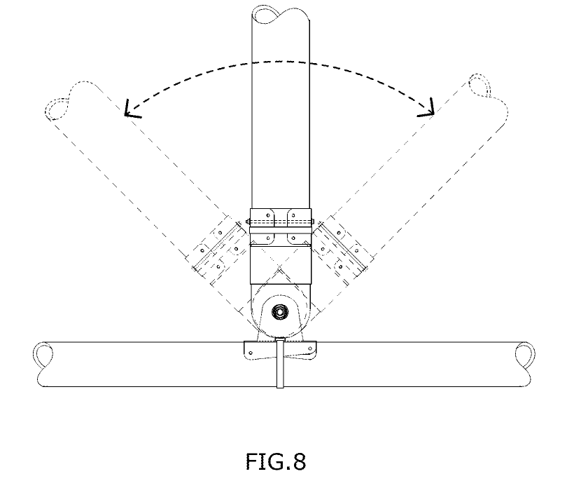

FIG. 8 shows angle variations of entire invention mounted on bamboo poles with potential for double pole side mounting.

### REFERENCE NUMERALS IN DRAWINGS

1. BL12B Pivot plate

2. Set screw hole

3. Cross bolt hole

4. Stainless Steel band

5. Pivot bolt, washer, lock washer, and nut assembly

6. BL12A Tube segment base

7. Bamboo pole

8. Slot for stainless steel band

9. Pivot bolt hole

10. Set screw

11. BL12B Receiver tube

12. BL12B Pivot plate base

13. Collar tab

14. BL12A Pivot plate

15. Cross bolt

### DETAILED DESCRIPTION

### Preferred Embodiment

My invention is a two element connector assembly which provides a connection between the side of one bamboo pole to the end of another bamboo pole (FIGS. 1, 2). Element 12A attaches to the side of one bamboo pole 7. Element 12B connector attaches to the end of the adjoining bamboo pole. The two elements make up the connector assembly and join together by the pivot bolt centered on the corresponding pivot plates (1,14) at a minimum 90 degree range of angles, 45 degrees on each side of perpendicular and parallel to the poles. Two 12B elements can attach to a single 12A element.

The 12A element tube segment base configuration 6 fits onto the round side of the pole. Said tube segment base is designed to flex to accommodate a pole diameter variation of 0.45 inch due to the thinness of the tube segment base 6. Said tube segment base also functions as a means of spreading the load across the surface area of the pole circumference. Said segment base also functions as a mounting surface for the fastening system (FIG. 2). The 12A element pivot plate 14 is welded to said tube segment base and has a hole for passing a central fastening band 4 through 8. Said pivot plate functions as a means of joining to element 12B corresponding pivot plate (1) attached with the pivot bolt assembly 5.

The 12A fastening system consists of 1000 psi steel banding 4. One or two bands are normally used depending on load requirements. Up to 6 set screws 10 can function as the sole means of fastening the 12A element to the pole but primarily function as a means to prevent rotation and sliding; or in redundant conjunction with the banding, which when combined can withstand the more critical loads eliminating the possibility of rotation, sliding, and pull out of the element from the pole. The unparalleled edges of said tube configuration are designed to offset the set screw holes to prevent pole splitting 2.

The 12B element tube configuration is fitted snuggly over the terminal end of the adjoining bamboo pole so that the tube collar tabs 13 conform to the pole irregularity. Only one inch of the exterior pole end is milled to the internal diameter of the tube receiver 11 where said pole is gently inserted with a rubber mallet until said pole contacts the pivot plate base 12 welded to the opposite end of said tube. The opposite end of the tube, past the receiver tube 11 is also welded to the pivot plate sides 1 as shown.

The 12B fastening system consists of a 1000 psi steel band 4 or equivalent, secured around the collar tab end of the element tube, with either cross bolt 3,15 and perpendicular to the tabs, primarily used for pullout and rotation of the pole, and or up to 4 set screws 2 either to be used with the cross bolt, banding, or independently in light applications. Said fastening variations depend on the estimated load for the connector on the pole, and for pullout under tension. As previously stated, the invention can be temporarily secured pending adjustment with adjustable circular clamps.

### OPERATION OF INVENTION

Poles of the bamboo structure are selected by diameter and length for the location in the frame construction design. Once a pole is sized the exact terminal end diameter is measured to determine selection of 12B element receiver tube 11 size for fitting to said pole. Size increments are % inch for said elements. The pole end is milled for precise fit to said receiver tube and inserted by means of gentle pounding with rubber or wood mallet tool until contact of pole end against pivot plate base 12 inside and at the end of said receiver tube. Stainless steel circular clamp is tightened around the collar tabs 13 to secure the 12B element temporarily. The exact same procedure is then repeated for the other end of the selected pole aligning the pivot plates of both ends as required by location of pole in the frame.

Next; the location(s) on the adjoining pole side(s) for the 12A element(s) is determined and measured for approximate diameter to the nearest ½ inch. This measurement will determine the size selection of said 12A element(s) since said elements are fabricated in increments of % inch. The tube segment base 6 of said element is then gently pounded as needed on a round bamboo surface to cause said tube to expand or contract to fit the location. All element tube segments are made with mild steel prescribed thickness to allow for flexing slightly without fatigue or other damage.

Next; the 12A element selected, is secured to its location by means of temporary clamp(s).

Next; the pole with the 12B elements is attached to the 12A element(s) by means of the pivot bolts 5 into the adjoining pivot plates 14,1. Final rotation of all said elements is made by loosening the clamps and retightening in precisely the exact angle needed for the pivot plate mating connection.

This procedure is repeated until all joints that collaborate in the frame have been installed. When this occurs the builder can choose to replace all the temporary clamps with the prescribed permanent fastening hardware options in the parts list. This procedure has been successfully performed thousands of times in many field testing structures, one which subsequently endured extreme wind and rain conditions with no significant structural problems.

### CONCLUSION, RAMIFICATIONS, AND SCOPE

Thus the reader will see why this two element bamboo connector assembly functions to the advantage of the builder in that the system allows for the characteristics of bamboo to be the focal point of the invention's adjustable function of joining at the terminal ends of one or two poles (which could also be any natural tree poles) to the side of a single pole in the simplest, yet most effective way to empower engineers, architects, and the builders to achieve accurate and strength enhancing results in constructing frames of natural bamboo or tree poles.

While the description of my invention contains many specificities these should not be construed as limitations of the scope of the invention, but rather as an exemplification of one preferred embodiment thereof. Many other variations have been used.

### Alternative Embodiments—No Drawings; Description Only

For example; the 12A element has been made with two pivot blades, each tilted 45 degrees, as viewed from the end, to either side of perpendicular from top dead center of the tube segment base, to allow for mounting two joining 12B elements at right angles to each other from this double 12A(v) element. Another example is the 12A tube segment base configuration. I am currently using the above stated specification configuration of said tube base due to low volume fabrication procedures which make straight sheared lines less expensive than manual torch cut curved lines. However when a higher volume of production will justify stamping this element part, I will change to the ultimate curvilinear configuration which I have tested to have certain advantages. The same is true for the 12B tube configuration. But in the end result, regardless of modification, the same principle construct is utilized as an improvement over prior art.

I claim:

1. A mechanical terminal end to side connector assembly that overcomes the inherent irregularities of natural bamboo and tree poles of all diameters and lengths to connect adjacent poles; this invention has been developed for various angles accommodated at the intersection it serves, comprising:

2. A terminal end connector element 12B of claim 1 wherein having a tube open at one end and configured with cuts wherein the tube collar tabs function as a means of expanding or contracting to conform to the irregularities of a natural bamboo or tree pole as the pole inserts into the receiver section of the tube wherein the first inch of said pole has been milled to fit said receiver interior diameter precisely until it contacts the base of the pivot plate welded to said tube in this section of the interior of said tube wherein said pivot plate extends in alignment with said tube to mate with,

3. the mating surface of the of the pivot plate of a side connector element(s) 12A of claim 1 wherein said element is attached to its tube segment base at a perpendicular 90 degree angle to the tube base, by means of a continuous weld, to the top dead center longitudinal direction of said tube segment base that functions as a means of attachment when fitted onto the side of an adjoining pole.

4. The pivot plate in element 12A claim 1 wherein configuration is two pivot plates that form a 90 degree angle with respect to each of the plates joined at the bottom located in the same orientation as the single pivot plate in claim 3 wherein the two pivot plates each tilt 45 degrees away from the original plate at perpendicular of the tube base.

5. Said 12A pivot plates claim 1,4 wherein are fastened to mating surface of adjoining 12B pivot plates by means of a bolt centered in and through both said adjoining pivot plates functioning to provide angle variations of the two connector elements, wherein both said connectors are fastened to their respective poles by means of,

6. stainless steel banding, and or screws in plurality, and for the 12B element only a cross bolt used together with the other fasteners or in various combinations that function to eliminate rotation, sliding, and for pullout under tension.

7. A variation of the 12A element claim 3, wherein a pivot plate has a different configuration allowing a pivot bolt hole and a second bolt hole for locking an angle to a mating pivot plate of the same configuration of said pivot plate element except that the second bolt position is a slot whose radius distance is equal to the distance between the holes of the mating pivot plate turned 90 degrees wherein the slot functions as a means of rotating 45 degrees, and said pivot plate is attached by a continuous weld to a tube segment base in the top dead center of the end view, and at the end of the side view so that when fit to a pole at the terminal end of the pole it joins to the side of the other pole by means of the two bolt openings functioning as a means of a second way to accomplish the end to side joint intersection with 45 degree rotation and a locking capability for use in simple frames such as scaffolding, racks, or furniture. The variations are not meant to be limited by the two cited as examples.
